(19) United States
(12) Patent Application Publication
(10) Pub. No.: US 2010/0162524 A1
(43) Pub. Date: Jul. 1, 2010

(54) HANDLE ASSEMBLY WITH FASTENING PORTION

(75) Inventors: FANG-SHU LIN, Chu-Nan (TW); SHAN-JU LIN, Chu-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/631,946

(22) Filed: Dec. 7, 2009

(30) Foreign Application Priority Data
Dec. 27, 2008 (CN) 200810306603.9

(51) Int. Cl. B25G 1/00; F16B 33/00

(52) U.S. Cl. 16/110.1; 411/378

(57) ABSTRACT

A handle assembly includes a handle body, a handle leg connected with the handle body, and fastening portion adjacent to an end of the handle leg. The handle leg includes a notch defined in an outer surface of the handle leg. The fastening portion includes a head portion and a connecting portion extending from the head portion to connect an external apparatus. The head portion includes a receiving hole defined by an internal surface thereof and a block protrusion formed on the internal surface of the receiving hole and extending towards an axis of the fastening portion. The block protrusion of the head portion is engagably received in the notch of the handle leg to enable the fastening portion be rotatable round the axis of the fastening portion.

### BACKGROUND

1. Technical Field

The present disclosure relates to a handle assembly, and more particularly to a handle assembly with fastening portion.

2. Description of Related Art

Referring to FIG. 6, a typical handle assembly 100 for attachment to a base plane 12 is shown. The handle assembly 100 includes a handle body 10 and a pair of L-shaped handle legs 11 perpendicularly extending from two ends of the handle body 10, respectively. Each of the pair of L-shaped handle legs 11 includes a first through hole 101. The base plane 12 includes two second through holes 111 corresponding to the first through holes 101, respectively. Two bolts 13 and two nuts 14 are provided to fasten the handle assembly 100 together with the base plane 12. In an assembly process, firstly, the first through holes 101 are formed at the pair of L-shaped handle legs 11; secondly, the second through holes 102 are formed on the base plane 12 in accordance with the first through holes 101, respectively; thirdly, each of the two bolts 14 is aligned to and inserted through one of the first through holes 101 and one of the second through holes 102; fourthly, The two bolts 14 are threaded into two nuts 13, respectively, so as to fasten the handle assembly 100 together with the base plane 12. As described above, the assembly process of the typical handle 100 is complicated.

It is thus desirable to provide a handle assembly which can overcome the described limitation.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is schematic, solid view of a handle assembly in accordance with an exemplary embodiment, the handle assembly including a fastening portion.

FIG. 2 is schematic, enlarged cross-sectional view taken along line III-III of the handle assembly shown in FIG. 1.

FIG. 3 is schematic, enlarged solid view of the fastening portion of FIG. 1.

FIG. 4 is schematic, solid view of a handle assembly in accordance with another exemplary embodiment, the handle assembly including a fastening portion.

FIG. 5 is schematic, enlarged cross-sectional view taken along line VI-VI of the handle assembly shown in FIG. 4.

FIG. 6 is schematic, exploded solid view of a conventional handle assembly.

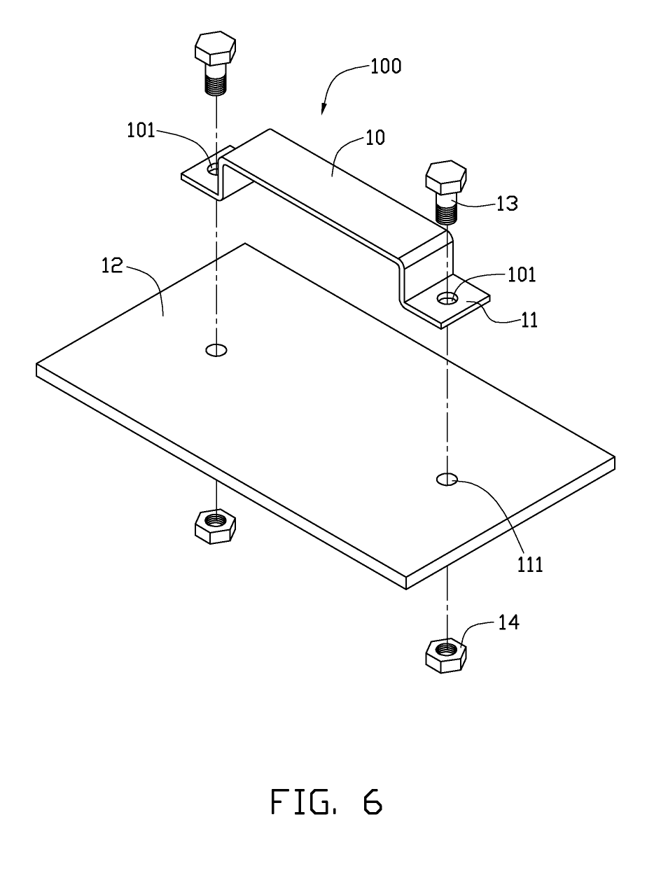

### DETAILED DESCRIPTION

Reference will now be made to the drawings to describe various inventive embodiments of the present disclosure in detail, wherein like numerals refer to like elements throughout.

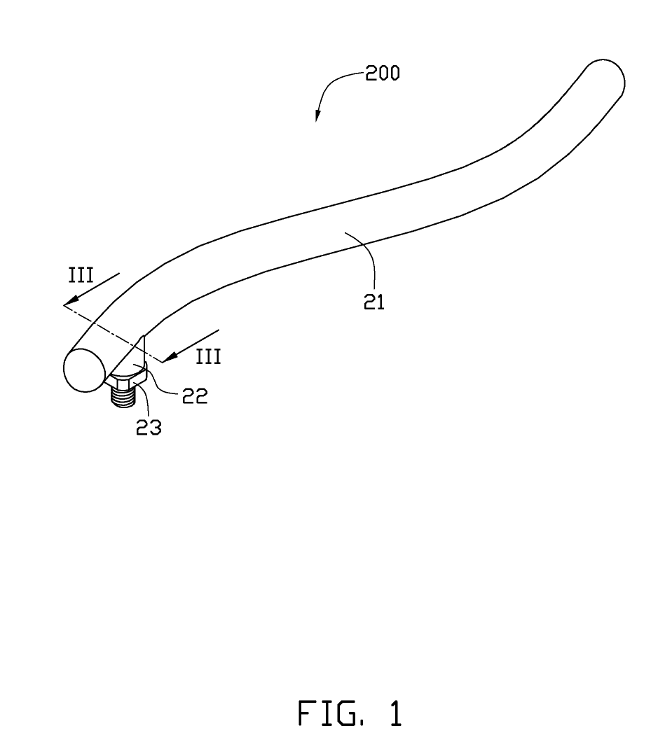

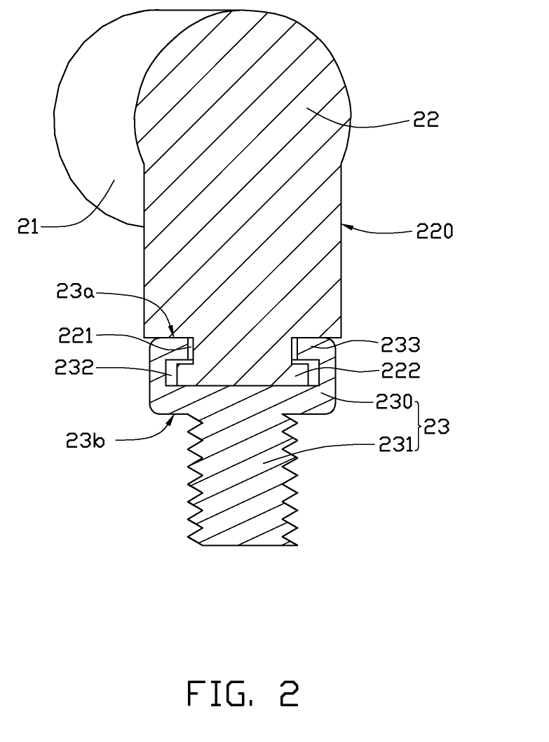

Referring to FIG. 1 and FIG. 2, a handle assembly 200 in accordance with an exemplary embodiment includes a handle body 21, a handle leg 22, and a fastening portion 23. In this embodiment, the handle body 21 is column-shaped and the handle leg 22 is perpendicularly connected to one end of the handle body 21.

The handle leg 22 is column-shaped and includes an outer cylinder 220. A ring-shaped notch 221 is defined in the outer cylinder 220 along a circumference of the column-shaped handle leg 22 distal from the handle body 21. A protruding head 222 is formed adjacent to the ring-shaped notch 221 at one end of the column-shaped handle leg 22.

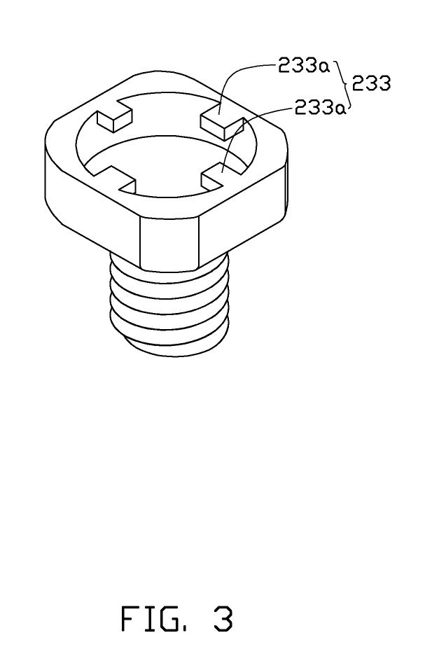

The fastening portion 23 is configured like a bolt and includes a head portion 230 and a threaded portion 231 connected to the head portion 230. The head portion 230 includes a first surface 23a and a second surface 23b opposite to the first surface 23a. A blind hole 232 extending from the first surface 23a towards the second surface 23b is defined in the head portion 230. A block protrusion 233 adjacent to the first surface 23a is formed on an interior surface of the blind hole 232 and extends towards an axis of the fastening portion 23. In this embodiment, the interior surface of the blind hole 232 is a cylinder and the block protrusion 233 is annular-shaped. Referring to FIG. 3, in an alternative embodiment, the block protrusion 233 can include a plurality of spaced protrusion units 233a arranged along a circumference of the entrance to the blind hole 232.

The threaded portion 231 is formed on the second surface 23b of the head portion 230 and extends distal from the first surface 23a of the head portion 230.

In assembling the fastening portion 23 to the handle leg 2222, the protruding head 222 of the handle leg 22 is received in the blind hole 232 of the head portion 230 and the block protrusion 233 of the head portion 230 is received and blocked in the ring-shaped notch 221 so as to make the fastening portion 23 rotate round the axis of the fastening portion 23.

To attach the handle assembly 200 to an external apparatus such as a door, a drawer or other item, the threaded portion 231 of the fastening portion 23 is screwed into a corresponding screw hole of the external apparatus to fasten the handle assembly 200 to the external apparatus. Assembly of the handle assembly 200 is very simple because the handle assembly 200 can easily be screwed to an external apparatus.

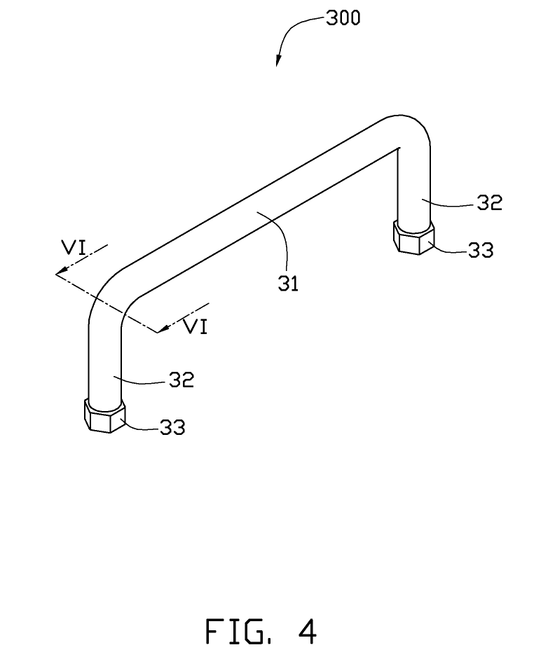

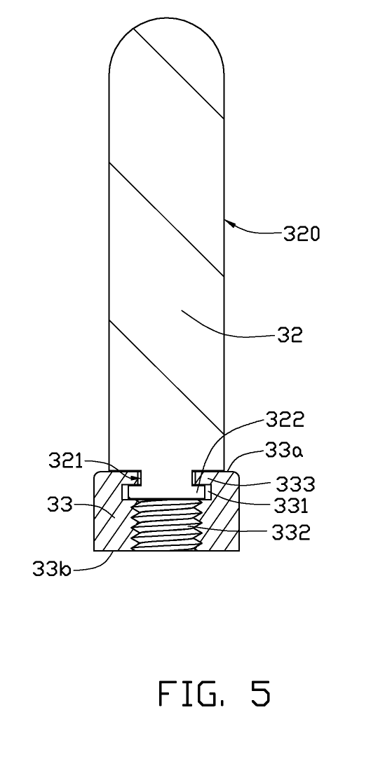

Referring to FIG. 4 and FIG. 5, a handle assembly 300 in accordance with another exemplary embodiment is similar to the handle assembly 200. The handle assembly 300 includes a handle body 31, a pair of handle legs 32, and a pair of fastening portions 33 adjacent to the handle legs 32, respectively. The pair of handle legs 32 perpendicularly extend from two ends of the handle body 31 and are integrally formed with the handle body 31 into a unitary piece.

The handle legs 32 are columnar and each include an outer cylinder 320. A ring-shaped notch 321 is defined in the outer cylinder 320 of each handle leg 32 along a circumference thereof distal from the handle body 31. A protruding head 322 is formed adjacent to the ring-shaped notch 321 at one end of each handle leg 32.

Each fastening portion 33 is configured like a nut and includes a head portion and a threaded portion. Each fastening portion 33 includes a first surface 33a and a second surface 33b opposite to the first surface 33a.

A receiving hole 331 which is similar to the blind hole 232 is defined in the head portion and extends from the first surface 33a towards the second surface 33b of the fastening portions 33. A screw hole 332 exposed at the second surface 33b is defined in the threaded portion and extends from the second surface 33b towards the first surface 33a of the fastening portions 33. In this embodiment, the receiving hole 331 and the screw hole 332 form a through hole which extends from the first surface 33a to the second surface 33b of the fastening portions 33. In an alternating embodiment, the receiving hole 331 and the screw hole 332 can be spaced apart from each other.

A block protrusion 333 adjacent to the first surface 33a is formed on an interior surface of the receiving hole 331 and extends towards an axis of the fastening portion 33. In this embodiment, the block protrusion 333 is annular-shaped.

To attach the handle assembly 300 to an external apparatus such as a door, a drawer or other item, the screw hole 332 of the threaded portion of the fastening portion 33 can be screwed onto a corresponding screw of an external apparatus to fasten the handle assembly 300 to the external apparatus. Assembly of the handle assembly 300 is very simple because the handle assembly 300 can easily be screwed to the external apparatus by only rotating the fastening portions 33 of the handle assembly 300.

Moreover, when the screws of the external apparatus are longer enough to be threaded into the screw holes 332 of the fastening portions 33 and resist with ends of the pair of handle legs 32, the handle assembly 300 can be further fastened with the external apparatus for each fastening portion 33 can generate a strength to make their block protrusion 333 contact and pull the corresponding protruding heads 332 of the handle legs 32 towards the screw of the external apparatus.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A handle assembly comprising:
a handle body,
a handle leg connected with the handle body, the handle leg comprising a notch defined in an outer surface of the handle leg, and
a fastening portion adjacent to an end of the handle leg, comprising:
a head portion comprising a receiving hole defined by an internal surface thereof, and a block protrusion formed on the internal surface of the receiving hole and extending towards an axis of the fastening portion, wherein the block protrusion of the head portion is engagably received in the notch of the handle leg to enable the fastening portion to be rotatable round the axis of the fastening portion, and
a connecting portion extending from the head portion for connection to an external apparatus.

2. The handle assembly of claim 1, wherein the handle leg further comprises a protruding head formed adjacent to the notch at the end of the handle leg, the protruding head being received in the receiving hole.

3. The handle assembly of claim 1, wherein the handle leg is cylindrical.

4. The handle assembly of claim 3, wherein the notch is ring-shaped and defined in the outer surface along a circumference of the handle leg distal from the handle body.

5. The handle assembly of claim 1, wherein the internal surface of the receiving hole is a cylinder.

6. The handle assembly of claim 5, wherein the block protrusion is annular-shaped.

7. The handle assembly of claim 5, wherein the block protrusion comprises a plurality of spaced protrusion units arranged along a circumference of the internal surface.

8. The handle assembly of claim 1, wherein the connecting portion comprises a screw.

9. The handle assembly of claim 1, wherein the connecting portion comprises a screw hole.

10. The handle assembly of claim 9, wherein the receiving hole and a screw hole form a through hole.

11. The handle assembly of claim 9, wherein the receiving hole and a screw hole are spaced apart from each other.

12. The handle assembly of claim 1, wherein the handle leg perpendicularly extends from an end of the handle body.

13. The handle assembly of claim 1, wherein the handle body and the handle legs are integrally formed into a unitary piece.
